(19) United States
(12) Patent Application Publication
(10) Pub. No.: US 2026/0247371 A1
(43) Pub. Date: Aug. 20, 2026

(54) METHOD AND DEVICE FOR TRANSMITTING OR RECEIVING SIGNAL IN WIRELESS COMMUNICATION SYSTEM

(71) Applicant: LG ELECTRONICS INC., Seoul (KR)

(72) Inventor: Gyeongcheol LEE, Seoul (KR)

(73) Assignee: LG ELECTRONICS INC., Seoul (KR)

(21) Appl. No.: 18/872,206

(22) PCT Filed: Jun. 19, 2023
(86) PCT No.: PCT/KR2023/008422

§ 371 Date: Dec. 5, 2024

Related U.S. Application Data
(60) Provisional application No. 63/353,854, filed on Jun. 21, 2022.

(51) Int. Cl. H04W 72/1268; H04W 72/0446; H04W 72/566; H04W 76/20

(52) U.S. Cl. CPC H04W 72/1268; H04W 72/0446; H04W 72/566; H04W 76/20

(57) ABSTRACT

A method and apparatus for performing operations in a wireless communication system disclosed herein may transmit/receive a data unit on a prioritized UL grant among the at least two UL grants. The at least two UL grants are prioritized based on a remaining time for each data unit corresponding each UL grant.

### CROSS-REFERENCE TO RELATED APPLICATIONS

This application is the National Stage filing under 35 U.S.C. 371 of International Application No. PCT/KR2023/008422, filed on Jun. 19, 2023, which claims the benefit of U.S. Provisional Application No. 63/353,854, filed on Jun. 21, 2022, the contents of which are all incorporated by reference herein in their entirety.

### TECHNICAL FIELD

The present disclosure relates to a method and apparatus for use in a wireless communication system.

### BACKGROUND

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of code division multiple access (CDMA) system, frequency division multiple access (FDMA) system, time division multiple access (TDMA) system, orthogonal frequency division multiple access (OFDMA) system, single carrier frequency division multiple access (SC-FDMA) system, and the like.

### SUMMARY

The object of the present disclosure is to provide a method and apparatus for transmitting and receiving signals efficiently in a wireless communication system.

It will be appreciated by persons skilled in the art that the objects that could be achieved with the present disclosure are not limited to what has been particularly described hereinabove and the above and other objects that the present disclosure could achieve will be more clearly understood from the following detailed description.

The present disclosure provides a method and apparatus for transmitting and receiving a signal in a wireless communication system.

In an aspect of the present disclosure, there is provided a method for performing operations of a User Equipment (UE) in a wireless communication system. The method may include: receiving a first UL grant for a first data unit and a second UL grant for a second data unit; based on transmission durations of the first and second UL grants being overlapped in a time domain, prioritizing the first and second UL grants based on a remaining time for the first data unit and a remaining time for the second data unit; and transmitting a MAC PDU including one of the first and second data units on a prioritized UL grant among the first and second UL grants.

In an aspect of the present disclosure, there is provided a method for performing operations of a Base Station (BS) in a wireless communication system. The method may include: transmitting a first UL grant for a first data unit and a second UL grant for a second data unit; and receiving a MAC PDU including one of the first and second data units on a prioritized UL grant among the first and second UL grants, wherein, based on transmission durations of the first and second UL grants being overlapped in a time domain, the first and second UL grants are prioritized based on a remaining time for the first data unit and a remaining time for the second data unit.

In other aspects of the present disclosure, an apparatus, a processor and a storage medium for performing operations of the UE and/or BS are provided.

The communication apparatus may include an autonomous driving vehicle communicable with at least a UE, a network, and another autonomous driving vehicle other than the communication apparatus.

The above-described aspects of the present disclosure are only some of the preferred embodiments of the present disclosure, and various embodiments reflecting the technical features of the present disclosure may be derived and understood from the following detailed description of the present disclosure by those skilled in the art.

According to an embodiment of the present disclosure, a communication apparatus may transmit and receive signals more efficiently in a different way from the prior art.

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF DRAWINGS

FIG. 1 illustrates a radio frame structure.

FIG. 2 illustrates a resource grid during the duration of a slot.

FIG. 3 illustrates a self-contained slot structure.

FIGS. 4 to 5 are diagrams for explaining embodiments of the present disclosure.

FIGS. 6 to 9 show an example of apparatuses according to an embodiment of the present disclosure.

### DETAILED DESCRIPTION

The following technology may be used in various wireless access systems such as code division multiple access (CDMA), frequency division multiple access (FDMA), time division multiple access (TDMA), orthogonal frequency division multiple access (OFDMA), single carrier frequency division multiple access (SC-FDMA), and so on. CDMA may be implemented as a radio technology such as universal terrestrial radio access (UTRA) or CDMA2000. TDMA may be implemented as a radio technology such as global system for mobile communications (GSM)/general packet radio service (GPRS)/enhanced data rates for GSM evolution (EDGE). OFDMA may be implemented as a radio technology such as institute of electrical and electronics engineers (IEEE) 802.11 (wireless fidelity (Wi-Fi)), IEEE 802.16 (worldwide interoperability for microwave access (WiMAX)), IEEE 802.20, evolved UTRA (E-UTRA), and so on. UTRA is a part of universal mobile telecommunications system (UMTS). 3rd generation partnership project (3GPP) long term evolution (LTE) is a part of evolved UMTS (E-UMTS) using E-UTRA, and LTE-advanced (LTE-A) is an evolution of 3GPP LTE. 3GPP new radio or new radio access technology (NR) is an evolved version of 3GPP LTE/LTE-A.

For clarity of description, the present disclosure will be described in the context of a 3GPP communication system (e.g., LTE and NR), which should not be construed as limiting the spirit of the present disclosure. LTE refers to a technology beyond 3GPP TS 36.xxx Release 8. Specifically, the LTE technology beyond 3GPP TS 36.xxx Release 10 is called LTE-A, and the LTE technology beyond 3GPP TS 36.xxx Release 13 is called LTE-A pro. 3GPP NR is the technology beyond 3GPP TS 38.xxx Release 15. LTE/NR may be referred to as a 3GPP system. “xxx” specifies a technical specification number. LTE/NR may be generically referred to as a 3GPP system. For the background technology, terminologies, abbreviations, and so on as used herein, refer to technical specifications published before the present disclosure. For example, the following documents may be referred to.

### 3GPP NR

38.211: Physical channels and modulation
38.212: Multiplexing and channel coding
38.213: Physical layer procedures for control
38.214: Physical layer procedures for data
38.300: NR and NG-RAN Overall Description
38.331: Radio Resource Control (RRC) protocol specification

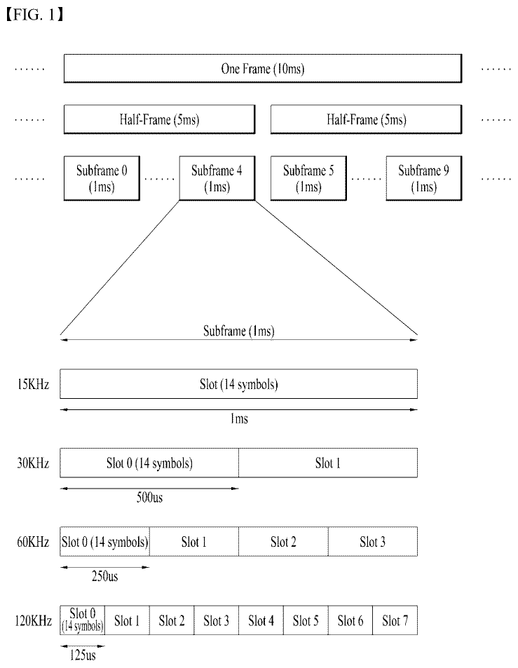

FIG. 1 illustrates a radio frame structure used for NR.

In NR, UL and DL transmissions are configured in frames. Each radio frame has a length of 10 ms and is divided into two 5-ms half-frames. Each half-frame is divided into five 1-ms subframes. A subframe is divided into one or more slots, and the number of slots in a subframe depends on a subcarrier spacing (SCS). Each slot includes 12 or 14 OFDM (A) symbols according to a cyclic prefix (CP). When a normal CP is used, each slot includes 14 OFDM symbols. When an extended CP is used, each slot includes 12 OFDM symbols. A symbol may include an OFDM symbol (or a CP-OFDM symbol) and an SC-FDMA symbol (or a discrete Fourier transform-spread-OFDM (DFT-s-OFDM) symbol).

Table 1 exemplarily illustrates that the number of symbols per slot, the number of slots per frame, and the number of slots per subframe vary according to SCSs in a normal CP case.

TABLE 1

| SCS (15*2\hat{ }u) | N^{slot}_{symb} | N^{frame, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: number of symbols in a slot
*N^{frame, u}ₛₗₒₜ: number of slots in a frame
*N^{subframe, u}ₛₗₒₜ: number of slots in a subframe

Table 2 illustrates that the number of symbols per slot, the number of slots per frame, and the number of slots per subframe vary according to SCSs in an extended CP case.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

In the NR system, different OFDM (A) numerologies (e.g., SCSs, CP lengths, and so on) may be configured for a plurality of cells aggregated for one UE. Accordingly, the (absolute time) duration of a time resource (e.g., a subframe, a slot, or a transmission time interval (TTI)) (for convenience, referred to as a time unit (TU)) composed of the same number of symbols may be configured differently between the aggregated cells.

In NR, various numerologies (or SCSs) may be supported to support various 5th generation (5G) services. For example, with an SCS of 15 kHz, a wide area in traditional cellular bands may be supported, while with an SCS of 30 kHz or 60 kHz, a dense urban area, a lower latency, and a wide carrier bandwidth may be supported. With an SCS of 60 kHz or higher, a bandwidth larger than 24.25 kHz may be supported to overcome phase noise.

An NR frequency band may be defined by two types of frequency ranges, FR1 and FR2. FR1 and FR2 may be configured as described in Table 3 below. FR2 may be millimeter wave (mmW).

TABLE 3

| Frequency Range | Corresponding frequency | |
|---|---|---|
| designation | range | Subcarrier Spacing |
| FR1 | 450 MHz-7125 MHz | 15, 30, 60 kHz |
| FR2 | 24250 MHz-52600 MHz | 60, 120, 240 kHz |

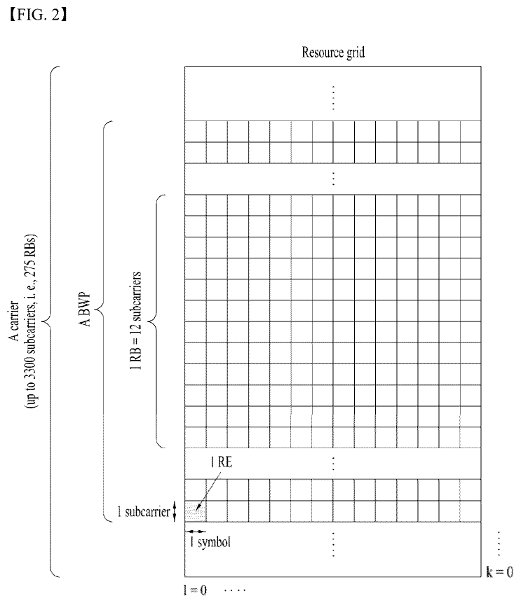

FIG. 2 illustrates a resource grid during the duration of one slot.

A slot includes a plurality of symbols in the time domain. For example, one slot includes 14 symbols in a normal CP case and 12 symbols in an extended CP case. A carrier includes a plurality of subcarriers in the frequency domain. A resource block (RB) may be defined by a plurality of (e.g., 12) consecutive subcarriers in the frequency domain. A plurality of RB interlaces (simply, interlaces) may be defined in the frequency domain. Interlace m∈{0, 1, . . . , M−1} may be composed of (common) RBs {m, M+m, 2M+m, 3M+m, . . . }. M denotes the number of interlaces. A bandwidth part (BWP) may be defined by a plurality of consecutive (physical) RBs ((P)RBs) in the frequency domain and correspond to one numerology (e.g., SCS, CP length, and so on). A carrier may include up to N (e.g., 5) BWPs. Data communication may be conducted in an active BWP, and only one BWP may be activated for one UE. Each element in a resource grid may be referred to as a resource element (RE), to which one complex symbol may be mapped.

In a wireless communication system, a UE receives information from a BS in downlink (DL), and the UE transmits information to the BS in uplink (UL). The information exchanged between the BS and UE includes data and various control information, and various physical channels/signals are present depending on the type/usage of the information exchanged therebetween. A physical channel corresponds to a set of resource elements (REs) carrying information originating from higher layers. A physical signal corresponds to a set of REs used by physical layers but does not carry information originating from the higher layers. The higher layers include a medium access control (MAC) layer, a radio link control (RLC) layer, a packet data convergence protocol (PDCP) layer, a radio resource control (RRC) layer, and so on.

DL physical channels include a physical broadcast channel (PBCH), a physical downlink shared channel (PDSCH), and a physical downlink control channel (PDCCH). DL physical signals include a DL reference signal (RS), a primary synchronization signal (PSS), and a secondary synchronization signal (SSS). The DL RS includes a demodulation reference signal (DM-RS), a phase tracking reference signal (PT-RS), and a channel state information reference signal (CSI-RS). UL physical channel include a physical random access channel (PRACH), a physical uplink shared channel (PUSCH), and a physical uplink control channel (PUCCH). UL physical signals include a UL RS. The UL RS includes a DM-RS, a PT-RS, and a sounding reference signal (SRS).

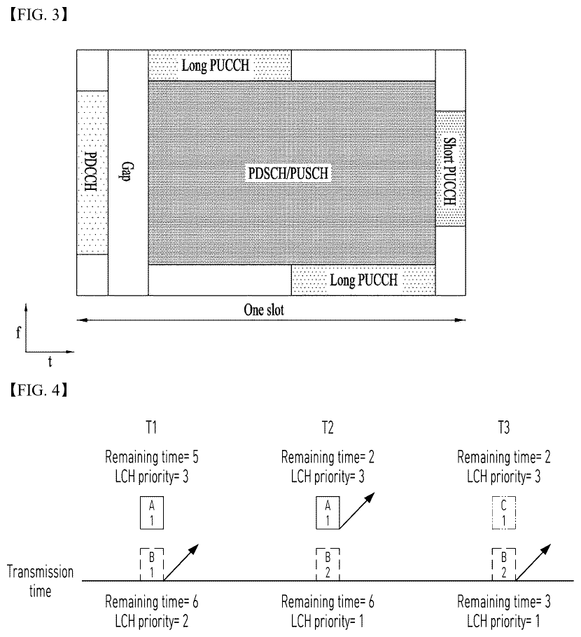

FIG. 3 illustrates a structure of a self-contained slot.

In the NR system, a frame has a self-contained structure in which a DL control channel, DL or UL data, a UL control channel, and the like may all be contained in one slot. For example, the first N symbols (hereinafter, DL control region) in the slot may be used to transmit a DL control channel, and the last M symbols (hereinafter, UL control region) in the slot may be used to transmit a UL control channel. N and M are integers greater than or equal to 0. A resource region (hereinafter, a data region) that is between the DL control region and the UL control region may be used for DL data transmission or UL data transmission. For example, the following configuration may be considered. Respective sections are listed in a temporal order.

In the present disclosure, a base station (BS) may be, for example, a gNode B (gNB).

### Inter-UE Prioritization Based on Remaining Time

The above-described contents (NR frame structure, etc.) may be applied in combination with methods proposed in the present specification to be described below, or may be supplemented to clarify the technical features of the methods proposed in the present specification.

Methods related to the NR system or LTE system described above, and needless to say, the technological spirit proposed in the present specification may be modified or replaced according to the term, expression, structure, etc. defined in each system to be implemented in the corresponding system.

In NR Rel-16, intra-UE prioritization (a.k.a. LCH based prioritization) is introduced to support URLLC (Ultra-Reliable and Low Latency Communications) and IIoT (Industrial Internet of Things) service. More specifically, when the UE has at least two UL grants which have overlapped transmission duration, only one of two overlapped UL grants is prioritized, i.e., data can be transmitted on one prioritized UL grant at the transmission time point. And another UL grant is considered as deprioritized UL grant. Data is not transmitted on this deprioritized UL grant at the expected transmission time point. For this prioritization between two UL grants, the priority of each UL grant is determined by the highest priority among priorities of the logical channels that are multiplexed (i.e. the MAC PDU to transmit is already stored in the HARQ buffer) or have data available that can be multiplexed (i.e. the MAC PDU to transmit is not stored in the HARQ buffer) in the MAC PDU. The UL grant having higher priority is prioritized over another UL grant having lower priority.

XR (Mixed reality) is approved as one WI for Rel-18. One of key requirement for XR is low latency and it is also required to be transmitted to the network before the time deadline of each packet exceeds. For this reason, it is expected that LCH based prioritization can be used to transmit the important data first than lower priority data.

However, the current LCH based prioritization may not be sufficient to support XR service completely because this cannot consider latency requirement of XR properly. For example, when both of UL grants are using for XR service and one of UL grants has the highest priority with the data having long remaining time till the time deadline but another of UL grants has the relatively lower priority with the data having very short remaining time till the time deadline, if the current LCH based prioritization is used in this situation, the UL grant having the highest priority is always prioritized and the data included in the lower priority UL grant may not be transmitted to the network on time and the data included in the lower priority UL grant may be discarded at the XR application because those data is not arrived on time.

From XR service perspective, actually the data in the lower priority UL grant should be prioritized and transmitted to the network first to avoid XR service degradation because the highest priority UL grant has enough remaining time and can be transmitted later without any XR service degradation and problems. Therefore, a new mechanism to handle overlapped UL grants for XR service should be considered to support this latency requirement and increase reliability of XR service and decrease XR service interruption.

When a UE receives at least two UL grants and transmission duration of these two UL grants is overlapped, the UE prioritizes one UL grant among the at least two UL grants based on the remaining time of each UL grant. Wherein the remaining time of UL grant is determined by the remaining time of data that are multiplexed (i.e. the MAC PDU to transmit is already stored in the HARQ buffer) and/or data that can be multiplexed (i.e. the MAC PDU to transmit is not stored in the HARQ buffer) in the MAC PDU. If the remaining time of one UL grant is smaller than another UL grant, the one UL grant is prioritized over the another UL grant even if the priority of the another UL grant based on logical channel priority is higher than the one UL grant. Wherein the priority of an uplink grant based on logical channel priority is determined by the highest priority among priorities of the logical channels that are multiplexed (i.e. the MAC PDU to transmit is already stored in the HARQ buffer) and/or have data available that can be multiplexed (i.e. the MAC PDU to transmit is not stored in the HARQ buffer) and/or the priority of MAC CE that can be multiplexed in the MAC PDU. The UE transmits the MAC PDU using the prioritized UL grant to the network.

The UE is configured with at least two logical channels (LCH) including a priority. The lower priority value of LCH has the higher priority for scheduling, e.g., when the LCH 1 has priority 1 and the LCH 2 has priority 2, the LCH 1 has higher priority than the LCH 2 for logical channel prioritization (LCP). The UE is configured with at least one scheduling request (SR) which may be associated with at least one configured logical channel. The priority of SR is determined by the highest priority among priority of the logical channels that triggered the SR. The UE can be configured by L1/L2/L3 signaling including RRC or higher layer signaling. A UL grant can be a dynamic UL grant (DG), configured UL grant (CG), or a UL grant given by a RAR, or other types of UL grant that can be used at the MAC layer.

The priority of each UL grant based on logical channel priority is determined by the highest priority among priorities of the logical channels that are multiplexed (i.e. the MAC PDU to transmit is already stored in the HARQ buffer) and/or have data available that can be multiplexed (i.e. the MAC PDU to transmit is not stored in the HARQ buffer) and/or the priority of MAC CE that can be multiplexed in the MAC PDU which is transmitted on each UL grant.

The remaining time of UL grant is determined by the remaining time of data that are multiplexed (i.e. the MAC PDU to transmit is already stored in the HARQ buffer) and/or data that can be multiplexed (i.e. the MAC PDU to transmit is not stored in the HARQ buffer) in the MAC PDU which is transmitted on each UL grant.

For example, if the UL grant can include a first data with remaining time 2 and a second data with remaining time 3 in the MAC PDU, the remaining time of the UL grant is 2 because the smallest remaining time of data included in the MAC PDU is 2, i.e., the smallest remaining time of data included in the MAC PDU.

Alternatively, the remaining time of UL grant may be determined by the average remaining time of data included in the MAC PDU or the median remaining time of data included in the MAC PDU, or the biggest remaining time of data included in the MAC PDU. The remaining time of data may be determined by one of followings:
Remaining time of the PDCP discard timer for this data, i.e., time remaining until the PDCP discard timer for this data expires;
Remaining time of the PDCP discard timer for the frame associated with this data, i.e., time remaining until the PDCP discard timer for the associated frame with this data expires;
Configured absolute time minus the elapsed time of this data from the time point of submitted to the AS layer, i.e., PDCP, RLC, or MAC layer. Wherein the configured absolute time may be different from the timer value of PDCP discard timer for this data or the frame associated with this data.

When the UE receives at least two UL grants and transmission duration of these two UL grants is overlapped, the UE determines the remaining time of each UL grant based on the remaining time of data multiplexed in a MAC PDU to be transmitted on the each UL grant and compares the determined remaining time of these two UL grants. The UE prioritizes one UL grant having the smallest remaining time among the at least two UL grants and deprioritizes other UL grants. The UE generates the MAC PDU and transmits the generated MAC PDU using the prioritized UL grant. The UE may not generate a MAC PDU for the deprioritized UL grant.

When the UE receives at least one UL grant and the transmission duration of this UL grant is overlapped with transmission of triggered SR, the UE determines the remaining time of this UL grant based on the remaining time of data multiplexed in a MAC PDU to be transmitted on this UL grant and the remaining time of the SR based on the remaining time of data buffered in the LCH triggered this SR. The UE compares the determined remaining time of the at least one UL grant and the SR and prioritizes the at least one UL grant or the SR.
If the remaining time of the at least one UL grant is smaller than the remaining time of the SR, the UE prioritizes the at least one UL grant and deprioritized the SR. Wherein the UE may not transmit the SR on the PUCCH for the deprioritized SR.
Else if the remaining time of the at least one UL grant is larger than the remaining time of the SR, the UE prioritizes the SR and deprioritized the at least one UL grant. Wherein the UE may not generate a MAC PDU for the deprioritized UL grant.

The UE transmits the MAC PDU using the prioritized UL grant or the prioritized SR on the PUCCH.

Wherein if the remaining time of the at least two UL grants is same or similar, the UE can choose one of the at least two UL grants based on the priority of UL grant determined by logical channel priority as described above. If the remaining time of the at least one UL grant is same or similar with the remaining time of the SR, the UE can choose the at least one UL grant or the SR based on the priority of the at least one UL grant determined by logical channel priority or the priority of the SR.

‘Similar’ means here that two value is not exactly same but the difference between two value is within some range which may be configured or pre-configured, i.e., if range is 2 and the first remaining time is 1 and the second remaining time is 2, we can say that the first remaining time and the second remaining time are similar.

Alternatively, the UE can be configured with a threshold. The UE may use the remaining time of UL grant or SR for prioritization among UL grants when the threshold is configured to the UE. If the UE is not configured with the threshold, the UE may not consider the remaining time of UL grant or SR and only considers the priority of each UL grant based on logical channel priority for prioritization among UL grants when transmission duration of the at least two UL grants is overlapped or transmission duration of the at least one UL grant and SR are overlapped. The threshold can be a specific value, percentage, or proportion like followings:
The number of milliseconds, e.g., 3 ms;
The number of slots or the number of symbols;
Percentage/proportion, e.g., 25% or ¼ means that the threshold can be 25% or ¼ of the timer value of the PDCP discard timer for the data.

When the UE is configured with the threshold, the UE can consider the remaining time of the at least two UL grants when the remaining time of at least one of the at least two UL grants is equal to or smaller than the threshold.

For example, when the threshold is configured with 3, if the remaining time of the first UL grant is 4 and the remaining time of the second UL grant is 2, the UE should prioritize one UL grant between the first UL grant and the second UL grant based on the remaining time of each UL grant because the remaining time of the second UL grant is smaller than the threshold.

If both UL grants has remaining time larger than the threshold, the UE prioritizes one UL grant between the first UL grant and second UL grant based on logical channel priority of each UL grant, not considering the remaining time of each UL grant.

Even if the UE is configured with the threshold, if the threshold is infinity or zero in some cases, the UE does not consider the remaining time of each UL grant and prioritizes one UL grant between the first UL grant and second UL grant based on logical channel priority of each UL grant.

If the remaining time of both the first UL grant and the second UL grant is equal to or smaller than the threshold, the UE prioritizes one UL grant between the first UL grant and second UL grant based on logical channel priority of each UL grant, not consider the remaining time of each UL grant.

If another configuration is configured to the UE, the UE may consider the remaining time of each UL grant and prioritize one UL grant between the first UL grant and second UL grant based on the remaining time of each UL grant, not considering logical channel priority of each UL grant. The UE may be indicated which prioritization scheme between based on the remaining time and based on the logical channel priority should be considered or prioritized first.

Alternatively, the remaining time of UL grant may be determined by the buffered time of data that are multiplexed (i.e. the MAC PDU to transmit is already stored in the HARQ buffer) and/or data that can be multiplexed (i.e. the MAC PDU to transmit is not stored in the HARQ buffer) in the MAC PDU. The longer buffered time has the smaller remaining time, i.e., if the longest buffered time of data may have the smallest remaining time. In this definition, long buffered data may be prioritized over the newly arrived data.

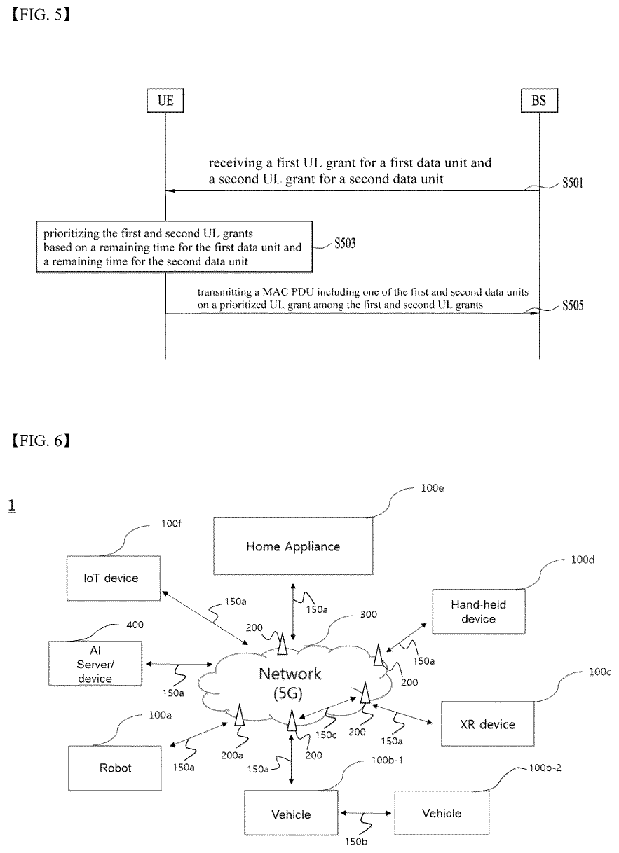

The example is given in FIG. 4. It is assumed that two UL grants are overlapped at T1, T2, and T3 and the remaining time and logical channel priority of UL grant for each MAC PDU at each time point T1/2/3 are given as in FIG. 4. In this example, A1, B1, B2 and C1 are MAC PDUs having multiplexed data for a UL grant. It is also supposed that the threshold is configured with 3 for remaining time based prioritization.

At T1, the remaining time and priority of UL grant for A1 are 5 and 3 respectively and the remaining time and priority of UL grant for B1 are 6 and 2 respectively. In this condition, the UE prioritizes one of two UL grants based on logical channel priority only because remaining time of UL grants for both A1 and B1 are not smaller that the threshold, i.e., 3. Even if the remaining time of B1 is 6 which is larger than the A1, the UE prioritizes the UL grant for B1 and transmits the MAC PDU B1 to the network using the UL grant for B1. The UE may not generate the MAC PDU A1 due to the deprioritized UL grant for A1.

At T2, the remaining time and priority of UL grant for A1 are 2 and 3 respectively and the remaining time and priority of UL grant for B2 are 6 and 1 respectively. The remaining time of A1 is reduced to 2 and this is smaller than the configured threshold 3. In this condition, the UE should prioritize one of UL grant based on the remaining time of each UL grant. Even if the UL grant for B2 has higher priority than UL grant for A1 based on the logical channel priority, the UE prioritizes the UL grant A1 over the UL grant for B2 since the remaining time of UL grant for A1 is smaller than the remaining time for UL grant for B2. The UE transmits the MAC PDU A1 to the network using the UL grant for A1. The UE may not generate the MAC PDU B2 due to the deprioritized UL grant for B2.

At T3, the remaining time and priority of UL grant for C1 are 2 and 3 respectively and the remaining time and priority of UL grant for B2 are 3 and 1 respectively. The remaining time of B2 is reduced to 3 and this is equal to the configured threshold 3 and the remaining time of UL grant for C1 is smaller than the configured threshold 3. The UE may prioritize one of two UL grants based on logical channel priority since remaining time for both C1 and B2 is equal to or smaller that the threshold 3, i.e., both MAC PDUs are urgent. The UE prioritizes the UL grant B2 over the UL grant for C1 since the priority of UL grant for B2 is larger than the priority for UL grant for C1. The UE transmits the MAC PDU B2 to the network using the UL grant for B2. The UE may not generate the MAC PDU C1 due to the deprioritized UL grant for C1. Alternatively, in this condition, if the UE is configured with configuration which makes the UE consider remaining time of UL grant first, the UE may prioritize the UL grant C1 over the UL grant for B2 since the remaining time of UL grant for C1 is smaller than the remaining time for UL grant for B2. The UE transmits the MAC PDU C1 to the network using the UL grant for C1. The UE may not generate the MAC PDU B2 due to the deprioritized UL grant for B2.

In order to transmit data unit(s) of the present disclosure on UL-SCH, a UE shall have uplink resources available to the UE. In order to receive data unit(s) of the present disclosure on DL-SCH, a UE shall have downlink resources available to the UE. The resource allocation includes time domain resource allocation and frequency domain resource allocation. In the present disclosure, uplink resource allocation is also referred to as uplink grant, and downlink resource allocation is also referred to as downlink assignment. An uplink grant is either received by the UE dynamically on PDCCH, in a Random Access Response, or configured to the UE semi-persistently by RRC. Downlink assignment is either received by the UE dynamically on the PDCCH, or configured to the UE semi-persistently by RRC signaling from the BS.

According to the present disclosure, when transmission duration of two UL grants is overlapped, the UE can consider the remaining time of UL grant and prioritize one of two UL grant based on the remaining time of UL grant. This intra-UE prioritization based on the remaining time can satisfy the latency requirement/reliability of XR service and avoid unnecessary data discard and service interruption.

Since examples of the above-described proposal method may also be included in one of implementation methods of the various embodiments, it is obvious that the examples are regarded as a sort of proposed methods. Although the above-proposed methods may be independently implemented, the proposed methods may be implemented in a combined (aggregated) form of a part of the proposed methods. A rule may be defined such that the BS informs the UE of information as to whether the proposed methods are applied (or information about rules of the proposed methods) through a predefined signal (e.g., a physical layer signal or a higher-layer signal). The higher layer may include, for example, one or more of functional layers such as MAC, RLC, PDCP, RRC, or SDAP.

Methods, embodiments, or descriptions for implementing the method proposed in the present specification may be separately applied or one or more methods (embodiments, or descriptions) may be combined and applied.

### Implementation Examples

FIG. 5 is a flowchart of a signal transmission/reception method according to embodiments of the present disclosure.

Referring to FIG. 5, an embodiment performed by the UE may include: receiving a first UL grant for a first data unit and a second UL grant for a second data unit (S501); prioritizing the first and second UL grants based on a remaining time for the first data unit and a remaining time for the second data unit (S503); transmitting a MAC PDU including one of the first and second data units on a prioritized UL grant among the first and second UL grants (S505). And, transmitting a first UL grant for a first data unit and a second UL grant for a second data unit (S501); receiving a MAC PDU including one of the first and second data units on a prioritized UL grant among the first and second UL grants (S505).

In FIG. 5, the first and second UL grants are prioritized based on transmission durations of the first and second UL grants being overlapped in a time domain.

The data transmission and reception may be performed based on one or more of the operations described in the section of ‘Inter-UE prioritization based on remaining time’.

For example, based on the remaining time for the first data unit being less than the remaining time for the second data unit, the MAC PDU including the first data unit is transmitted on the first UL grant. And, based on the remaining time for the first data unit being larger than the remaining time for the second data unit, the MAC PDU including the second data unit is transmitted on the second UL grant. based on the remaining time for the first data unit being equal to the remaining time for the second data unit, the first and the second UL grant are prioritized based on a logical channel priority related to the first data unit and a logical channel priority related to the second data unit.

In addition, referring to FIG. 4, the first and the second UL grants are prioritized based on a threshold. The threshold can be configured via DCI or RRC signaling. As described above, the threshold can be a specific value, percentage, or proportion. For example, the threshold can be the number of absolute time, the number of slot, the number of symbol, combination of the number of slot and symbol, percentage of the timer value of the PDCP discard timer, and/or proportion of the timer value of the PDCP discard timer.

Optionally, when the UE is not configured with the threshold or when the UE is configured with the threshold to zero or infinity, the first and the second UL grants are prioritized based on a logical channel priority related to the first data unit and a logical channel priority related to the second data unit, not based on the remaining time for the first data unit and the remaining time for the second data unit.

When the UE is configured with the threshold, based on either the remaining time for the first data unit or the remaining time for the second data unit being equal to or less than the threshold, the first and second UL grants are prioritized based on the remaining time for the first data unit and the remaining time for the second data unit, as described in T2 of FIG. 4.

When the UE is configured with the threshold, based on both of the remaining time for the first data unit and the remaining time for the second data unit being equal to or less than the threshold, the first and the second UL grants prioritized based on a logical channel priority related to the first data unit and a logical channel priority related to the second data unit, as described in T3 of FIG. 4.

When the UE is configured with the threshold, based on both of the remaining time for the first data unit and the remaining time for the second data unit being larger than the threshold, the first and the second UL grants are prioritized based on a logical channel priority related to the first data unit and a logical channel priority related to the second data unit, as described in T1 of FIG. 4.

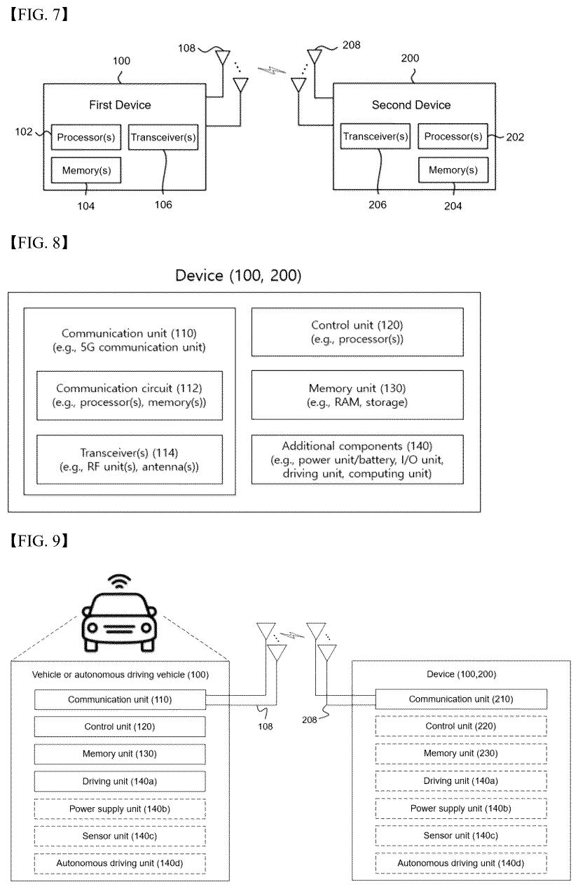

The operations described with reference to FIG. 6 may be additionally performed in combination with at least one of the operations described with reference to FIGS. 1 to 5 and/or the operations described in the section of ‘Inter-UE prioritization based on remaining time’.

Example of Communication System to which the Present Disclosure is Applied

The various descriptions, functions, procedures, proposals, methods, and/or operation flowcharts of the present disclosure described herein may be applied to, but not limited to, various fields requiring wireless communication/connectivity (e.g., 5G) between devices.

More specific examples will be described below with reference to the drawings. In the following drawings/description, like reference numerals denote the same or corresponding hardware blocks, software blocks, or function blocks, unless otherwise specified.

FIG. 6 illustrates a communication system 1 applied to the present disclosure.

Referring to FIG. 6, the communication system 1 applied to the present disclosure includes wireless devices, BSs, and a network. A wireless device is a device performing communication using radio access technology (RAT) (e.g., 5G NR (or New RAT) or LTE), also referred to as a communication/radio/5G device. The wireless devices may include, not limited to, a robot 100a, vehicles 100b-1 and 100b-2, an extended reality (XR) device 100c, a hand-held device 100d, a home appliance 100e, an IoT device 100f, and an artificial intelligence (AI) device/server 400. For example, the vehicles may include a vehicle having a wireless communication function, an autonomous driving vehicle, and a vehicle capable of vehicle-to-vehicle (V2V) communication. Herein, the vehicles may include an unmanned aerial vehicle (UAV) (e.g., a drone). The XR device may include an augmented reality (AR)/virtual reality (VR)/mixed reality (MR) device and may be implemented in the form of a head-mounted device (HMD), a head-up display (HUD) mounted in a vehicle, a television (TV), a smartphone, a computer, a wearable device, a home appliance, a digital signage, a vehicle, a robot, and so on. The hand-held device may include a smartphone, a smart pad, a wearable device (e.g., a smart watch or smart glasses), and a computer (e.g., a laptop). The home appliance may include a TV, a refrigerator, a washing machine, and so on. The IoT device may include a sensor, a smart meter, and so on. For example, the BSs and the network may be implemented as wireless devices, and a specific wireless device 200a may operate as a BS/network node for other wireless devices.

The wireless devices 100a to 100f may be connected to the network 300 via the BSs 200. An AI technology may be applied to the wireless devices 100a to 100f, and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without intervention of the BSs/network. For example, the vehicles 100b-1 and 100b-2 may perform direct communication (e.g., V2V/vehicle-to-everything (V2X) communication). The IoT device (e.g., a sensor) may perform direct communication with other IoT devices (e.g., sensors) or other wireless devices 100a to 100f.

Wireless communication/connections 150a, 150b, and 150c may be established between the wireless devices 100a to 100f/BS 200 and between the BSs 200. Herein, the wireless communication/connections may be established through various RATs (e.g., 5G NR) such as UL/DL communication 150a, sidelink communication 150b (or, D2D communication), or inter-BS communication (e.g., relay or integrated access backhaul (IAB)). Wireless signals may be transmitted and received between the wireless devices, between the wireless devices and the BSs, and between the BSs through the wireless communication/connections 150a, 150b, and 150c. For example, signals may be transmitted and receive don various physical channels through the wireless communication/connections 150a, 150b and 150c. To this end, at least a part of various configuration information configuring processes, various signal processing processes (e.g., channel encoding/decoding, modulation/demodulation, and resource mapping/demapping), and resource allocation processes, for transmitting/receiving wireless signals, may be performed based on the various proposals of the present disclosure.

Example of Wireless Device to which the Present Disclosure is Applied

FIG. 7 illustrates wireless devices applicable to the present disclosure.

Referring to FIG. 7, a first wireless device 100 and a second wireless device 200 may transmit wireless signals through a variety of RATs (e.g., LTE and NR). {The first wireless device 100 and the second wireless device 200} may correspond to {the wireless device 100x and the BS 200} and/or {the wireless device 100x and the wireless device 100x} of FIG. 6.

The first wireless device 100 may include one or more processors 102 and one or more memories 104, and further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operation flowcharts disclosed in this document. For example, the processor(s) 102 may process information in the memory(s) 104 to generate first information/signals and then transmit wireless signals including the first information/signals through the transceiver(s) 106. The processor(s) 102 may receive wireless signals including second information/signals through the transceiver(s) 106 and then store information obtained by processing the second information/signals in the memory(s) 104. The memory(s) 104 may be connected to the processor(s) 102 and may store various pieces of information related to operations of the processor(s) 102. For example, the memory(s) 104 may store software code including instructions for performing all or a part of processes controlled by the processor(s) 102 or for performing the descriptions, functions, procedures, proposals, methods, and/or operation flowcharts disclosed in this document. The processor(s) 102 and the memory(s) 104 may be a part of a communication modem/circuit/chip designed to implement RAT (e.g., LTE or NR). The transceiver(s) 106 may be connected to the processor(s) 102 and transmit and/or receive wireless signals through the one or more antennas 108. Each of the transceiver(s) 106 may include a transmitter and/or a receiver. The transceiver(s) 106 may be interchangeably used with radio frequency (RF) unit(s). In the present disclosure, the wireless device may be a communication modem/circuit/chip.

The second wireless device 200 may include one or more processors 202 and one or more memories 204, and further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operation flowcharts disclosed in this document. For example, the processor(s) 202 may process information in the memory(s) 204 to generate third information/signals and then transmit wireless signals including the third information/signals through the transceiver(s) 206. The processor(s) 202 may receive wireless signals including fourth information/signals through the transceiver(s) 106 and then store information obtained by processing the fourth information/signals in the memory(s) 204. The memory(s) 204 may be connected to the processor(s) 202 and store various pieces of information related to operations of the processor(s) 202. For example, the memory(s) 204 may store software code including instructions for performing all or a part of processes controlled by the processor(s) 202 or for performing the descriptions, functions, procedures, proposals, methods, and/or operation flowcharts disclosed in this document. The processor(s) 202 and the memory(s) 204 may be a part of a communication modem/circuit/chip designed to implement RAT (e.g., LTE or NR). The transceiver(s) 206 may be connected to the processor(s) 202 and transmit and/or receive wireless signals through the one or more antennas 208. Each of the transceiver(s) 206 may include a transmitter and/or a receiver. The transceiver(s) 206 may be interchangeably used with RF unit(s). In the present disclosure, the wireless device may be a communication modem/circuit/chip.

Now, hardware elements of the wireless devices 100 and 200 will be described in greater detail. One or more protocol layers may be implemented by, not limited to, one or more processors 102 and 202. For example, the one or more processors 102 and 202 may implement one or more layers (e.g., functional layers such as physical (PHY), medium access control (MAC), radio link control (RLC), packet data convergence protocol (PDCP), RRC, and service data adaptation protocol (SDAP)). The one or more processors 102 and 202 may generate one or more protocol data units (PDUs) and/or one or more service data Units (SDUs) according to the descriptions, functions, procedures, proposals, methods, and/or operation flowcharts disclosed in this document. The one or more processors 102 and 202 may generate messages, control information, data, or information according to the descriptions, functions, procedures, proposals, methods, and/or operation flowcharts disclosed in this document and provide the messages, control information, data, or information to one or more transceivers 106 and 206. The one or more processors 102 and 202 may generate signals (e.g., baseband signals) including PDUs, SDUs, messages, control information, data, or information according to the descriptions, functions, procedures, proposals, methods, and/or operation flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operation flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. For example, one or more application specific integrated circuits (ASICs), one or more digital signal processors (DSPs), one or more digital signal processing devices (DSPDs), one or more programmable logic devices (PLDs), or one or more field programmable gate arrays (FPGAs) may be included in the one or more processors 102 and 202. The descriptions, functions, procedures, proposals, methods, and/or operation flowcharts disclosed in this document may be implemented using firmware or software, and the firmware or software may be configured to include the modules, procedures, or functions. Firmware or software configured to perform the descriptions, functions, procedures, proposals, methods, and/or operation flowcharts disclosed in this document may be included in the one or more processors 102 and 202 or may be stored in the one or more memories 104 and 204 and executed by the one or more processors 102 and 202. The descriptions, functions, procedures, proposals, methods, and/or operation flowcharts disclosed in this document may be implemented using firmware or software in the form of code, an instruction, and/or a set of instructions.

The one or more memories 104 and 204 may be connected to the one or more processors 102 and 202 and store various types of data, signals, messages, information, programs, code, instructions, and/or commands. The one or more memories 104 and 204 may be configured to include read-only memories (ROMs), random access memories (RAMs), electrically erasable programmable read-only memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or wireless signals/channels, mentioned in the methods and/or operation flowcharts of this document, to one or more other devices. The one or more transceivers 106 and 206 may receive user data, control information, and/or wireless signals/channels, mentioned in the descriptions, functions, procedures, proposals, methods, and/or operation flowcharts disclosed in this document, from one or more other devices. For example, the one or more transceivers 106 and 206 may be connected to the one or more processors 102 and 202 and transmit and receive wireless signals. For example, the one or more processors 102 and 202 may perform control so that the one or more transceivers 106 and 206 may transmit user data, control information, or wireless signals to one or more other devices. The one or more processors 102 and 202 may perform control so that the one or more transceivers 106 and 206 may receive user data, control information, or wireless signals from one or more other devices. The one or more transceivers 106 and 206 may be connected to the one or more antennas 108 and 208 and the one or more transceivers 106 and 206 may be configured to transmit and receive user data, control information, and/or wireless signals/channels, mentioned in the descriptions, functions, procedures, proposals, methods, and/or operation flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received wireless signals/channels from RF band signals into baseband signals in order to process received user data, control information, and wireless signals/channels using the one or more processors 102 and 202. The one or more transceivers 106 and 206 may convert the user data, control information, and wireless signals/channels processed using the one or more processors 102 and 202 from the baseband signals into the RF band signals. To this end, the one or more transceivers 106 and 206 may include (analog) oscillators and/or filters.

Example of Use of Wireless Device to which the Present Disclosure is Applied

FIG. 8 illustrates another example of a wireless device applied to the present disclosure. The wireless device may be implemented in various forms according to a use case/service (refer to FIG. 6).

Referring to FIG. 8, wireless devices 100 and 200 may correspond to the wireless devices 100 and 200 of FIG. 7 and may be configured to include various elements, components, units/portions, and/or modules. For example, each of the wireless devices 100 and 200 may include a communication unit 110, a control unit 120, a memory unit 130, and additional components 140. The communication unit 110 may include a communication circuit 112 and transceiver(s) 114. For example, the communication circuit 112 may include the one or more processors 102 and 202 and/or the one or more memories 104 and 204 of FIG. 7. For example, the transceiver(s) 114 may include the one or more transceivers 106 and 206 and/or the one or more antennas 108 and 208 of FIG. 7. The control unit 120 is electrically connected to the communication unit 110, the memory 130, and the additional components 140 and provides overall control to the wireless device. For example, the control unit 120 may control an electric/mechanical operation of the wireless device based on programs/code/instructions/information stored in the memory unit 130. The control unit 120 may transmit the information stored in the memory unit 130 to the outside (e.g., other communication devices) via the communication unit 110 through a wireless/wired interface or store, in the memory unit 130, information received through the wireless/wired interface from the outside (e.g., other communication devices) via the communication unit 110.

The additional components 140 may be configured in various manners according to type of the wireless device. For example, the additional components 140 may include at least one of a power unit/battery, input/output (I/O) unit, a driving unit, and a computing unit. The wireless device may be implemented in the form of, not limited to, the robot (100a of FIG. 6), the vehicles (100b-1 and 100b-2 of FIG. 6), the XR device (100c of FIG. 6), the hand-held device (100d of FIG. 6), the home appliance (100e of FIG. 6), the IoT device (100f of FIG. 6), a digital broadcasting terminal, a hologram device, a public safety device, an MTC device, a medical device, a FinTech device (or a finance device), a security device, a climate/environment device, the AI server/device (400 of FIG. 6), the BSs (200 of FIG. 6), a network node, or the like. The wireless device may be mobile or fixed according to a use case/service.

In FIG. 8, all of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module in the wireless devices 100 and 200 may further include one or more elements. For example, the control unit 120 may be configured with a set of one or more processors. For example, the control unit 120 may be configured with a set of a communication control processor, an application processor, an electronic control unit (ECU), a graphical processing unit, and a memory control processor. In another example, the memory 130 may be configured with a RAM, a dynamic RAM (DRAM), a ROM, a flash memory, a volatile memory, a non-volatile memory, and/or a combination thereof.

Example of Vehicle or Autonomous Driving Vehicle to which the Present Disclosure is Applied

FIG. 9 illustrates a vehicle or an autonomous driving vehicle applied to the present disclosure. The vehicle or autonomous driving vehicle may be implemented as a mobile robot, a car, a train, a manned/unmanned aerial vehicle (AV), a ship, or the like.

Referring to FIG. 9, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 8, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an ECU. The driving unit 140a may enable the vehicle or the autonomous driving vehicle 100 to drive on a road. The driving unit 140a may include an engine, a motor, a powertrain, a wheel, a brake, a steering device, and so on. The power supply unit 140b may supply power to the vehicle or the autonomous driving vehicle 100 and include a wired/wireless charging circuit, a battery, and so on. The sensor unit 140c may acquire information about a vehicle state, ambient environment information, user information, and so on. The sensor unit 140c may include an inertial measurement unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, and so on. The autonomous driving unit 140d may implement technology for maintaining a lane on which the vehicle is driving, technology for automatically adjusting speed, such as adaptive cruise control, technology for autonomously driving along a determined path, technology for driving by automatically setting a route if a destination is set, and the like.

For example, the communication unit 110 may receive map data, traffic information data, and so on from an external server. The autonomous driving unit 140d may generate an autonomous driving route and a driving plan from the obtained data. The control unit 120 may control the driving unit 140a such that the vehicle or autonomous driving vehicle 100 may move along the autonomous driving route according to the driving plan (e.g., speed/direction control). During autonomous driving, the communication unit 110 may aperiodically/periodically acquire recent traffic information data from the external server and acquire surrounding traffic information data from neighboring vehicles. During autonomous driving, the sensor unit 140c may obtain information about a vehicle state and/or surrounding environment information. The autonomous driving unit 140d may update the autonomous driving route and the driving plan based on the newly obtained data/information. The communication unit 110 may transfer information about a vehicle position, the autonomous driving route, and/or the driving plan to the external server. The external server may predict traffic information data using AI technology based on the information collected from vehicles or autonomous driving vehicles and provide the predicted traffic information data to the vehicles or the autonomous driving vehicles.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

As described above, the present disclosure is applicable to various wireless communication systems.

1. A method for performing operations of a User Equipment (UE) in a wireless communication system, the method comprising:
receiving a first UL grant for a first data unit and a second UL grant for a second data unit;
based on transmission durations of the first and second UL grants being overlapped in a time domain, prioritizing the first and second UL grants based on a remaining time for the first data unit and a remaining time for the second data unit; and
transmitting a MAC PDU including one of the first and second data units on a prioritized UL grant among the first and second UL grants.

2. The method of claim 1, wherein, based on the remaining time for the first data unit being less than the remaining time for the second data unit, the MAC PDU including the first data unit is transmitted on the first UL grant, and
wherein, based on the remaining time for the first data unit being larger than the remaining time for the second data unit, the MAC PDU including the second data unit is transmitted on the second UL grant.

3. The method of claim 1, wherein, based on the remaining time for the first data unit being equal to the remaining time for the second data unit, the first and the second UL grant are prioritized based on a logical channel priority related to the first data unit and a logical channel priority related to the second data unit.

4. The method of claim 1, wherein the first and second UL grants are prioritized based on a threshold.

5. The method of claim 4, wherein the threshold is configured via RRC signaling.

6. The method of claim 4, wherein, based on either the remaining time for the first data unit or the remaining time for the second data unit being equal to or less than the threshold, the first and second UL grants are prioritized based on the remaining time for the first data unit and the remaining time for the second data unit.

7. The method of claim 4, further comprising:
based on the threshold being not configured, prioritizing the first and the second UL grants based on a logical channel priority related to the first data unit and a logical channel priority related to the second data unit.

8. The method of claim 4, further comprising:
based on the threshold being configured to zero or infinity, prioritizing the first and the second UL grants based on a logical channel priority related to the first data unit and a logical channel priority related to the second data unit.

9. The method of claim 4, further comprising:
based on both of the remaining time for the first data unit and the remaining time for the second data unit being equal to or less than the threshold, prioritizing the first and the second UL grants based on a logical channel priority related to the first data unit and a logical channel priority related to the second data unit.

10. The method of claim 4, further comprising:
based on both of the remaining time for the first data unit and the remaining time for the second data unit being larger than the threshold, prioritizing the first and the second UL grants based on a logical channel priority related to the first data unit and a logical channel priority related to the second data unit.

11. A user equipment (UE) in a wireless communication system, the UE comprising:
at least one transceiver;
at least one processor; and
at least one computer memory operably connectable to the at least one processor and storing instructions that, when executed, cause the at least one processor to perform operations comprising:
receiving a first UL grant for a first data unit and a second UL grant for a second data unit;
based on transmission durations of the first and second UL grants being overlapped in a time domain, prioritizing the first and second UL grants based on a remaining time for the first data unit and a remaining time for the second data unit; and
transmitting a MAC PDU including one of the first and second data units on a prioritized UL grant among the first and second UL grants.

12-14. (canceled)

15. A base station (BS) in a wireless communication system, the BS comprising:
at least one transceiver;
at least one processor; and
at least one computer memory operably connectable to the at least one processor and storing instructions that, when executed, cause the at least one processor to perform operations comprising:
transmitting a first UL grant for a first data unit and a second UL grant for a second data unit; and
receiving a MAC PDU including one of the first and second data units on a prioritized UL grant among the first and second UL grants,
wherein, based on transmission durations of the first and second UL grants being overlapped in a time domain, the first and second UL grants are prioritized based on a remaining time for the first data unit and a remaining time for the second data unit.
